(19) United States
(12) Patent Application Publication
(10) Pub. No.: US 2023/0140042 A1
(43) Pub. Date: May 4, 2023

(54) METHOD AND APPARATUS FOR SIGNALING OCCLUDE-FREE REGIONS IN 360 VIDEO CONFERENCING

(71) Applicant: Tencent America LLC, Palo Alto, CA (US)

(72) Inventor: Iraj SODAGAR, Palo Alto, CA (US)

(73) Assignee: Tencent America LLC, Palo Alto, CA (US)

(21) Appl. No.: 17/973,301

(22) Filed: Oct. 25, 2022

Related U.S. Application Data
(60) Provisional application No. 63/275,795, filed on Nov. 4, 2021.

(51) Int. Cl. H04N 7/15; H04N 7/14; H04N 5/232

(52) U.S. Cl. CPC H04N 7/152; H04N 7/147; H04N 5/23238

(57) ABSTRACT

A technique for defining occlude free regions in 360 video conferencing, including: receiving a first video input that is a 360-degree video conference; receiving one or more second video inputs; defining one or more regions in the first video input as occlude-free regions that do not overlap with any other image or video; transmitting the one or more occlude-free regions to a receiver; and rendering an output video that includes the first video input with the one or more second video inputs overlaid in a region not including the one or more occlude-free regions.

### CROSS-REFERENCE TO RELATED APPLICATION(S)

This application is based on and claims priority to U.S. Patent Application No. 63/275,795, filed on Nov. 4, 2021, the disclosure of which is incorporated herein by reference in its entirety.

### TECHNICAL FIELD

The present disclosure provides a method to signal occlude-free regions in 360 video conferencing. An occlude-free region in a 360 video is a region of the 360-video that is not be covered by any overlays since the occlude-free region contains important information.

### BACKGROUND

3GPP TS26.114 defines a video conferencing system for mobile handsets. This specification supports video conferencing with the terminals that support capturing and transmitting 360 videos. The standard also supports adding overlays to 360 videos. The 360 video and corresponding overlays may get rendered together with other 2-d videos from other remote participants in the conference call.

The current 5G media streaming architecture defined in 3GPP TS26.114 provides the general framework for video conferencing over mobile networks. During video conferencing, a remote participant may receive a 360 video from a first room and a 2-d video from another user. The user may want to see both videos on his/her terminal. However, if the user wants to take the most advantage of the device display, the first room's 360-video may need to take the entire screen of the another user's device, and then, the 2-d video from the another user must be overlaid on top of first room's.

The current standard doesn't define any method for signaling the first room's occlude-free regions. Those regions are the regions of 360 video of the first room that should have important information (the participants in the room, or presentation display) and should not be occluded by overlaying video from other users in a receiving remote terminal.

### SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

This disclosure provides a method to signal occlude-free regions in 360 video

conferencing.

According to an exemplary embodiment, a method of defining occlude free regions in 360 video conferencing performed by at least one or more processors. The method includes receiving a first video input that corresponding to a 360-degree video conference. The method further includes receiving one or more second video inputs. The method further includes defining one or more regions in the first video input as occlude-free regions that do not overlap with any other image or video. The method further includes transmitting the one or more occlude-free regions to a receiver; and rendering an output video that includes the first video input with the one or more second video inputs overlaid in a region not including the one or more occlude-free regions.

According to an exemplary embodiment, an apparatus for defining occlude free regions in 360 video conferencing. The apparatus includes at least one memory configured to store computer program code and at least one processor configured to access the computer program code and operate as instructed by the computer program code. The computer program code includes first receiving code configured to cause the at least one processor to receive a first video input that corresponding to a 360-degree video conference. The computer program code further includes second receiving code configured to cause the at least one processor to receive one or more second video inputs. The computer program code further includes defining code configured to cause the at least one processor to define one or more regions in the first video input as occlude-free regions that do not overlap with any other image or video. The computer program code further includes transmitting code configured to cause the at least one processor to transmit the one or more occlude-free regions to a receiver; and rendering code configured to cause the at least one processor to render an output video that includes the first video input with the one or more second video inputs overlaid in a region not including the one or more occlude-free regions.

According to an exemplary embodiment, a non-transitory computer readable medium having stored thereon computer instructions that when executed by at least one processor cause the at least one processor to execute a method. The method includes receiving a first video input that corresponding to a 360-degree video conference. The method further includes receiving one or more second video inputs. The method further includes defining one or more regions in the first video input as occlude-free regions that do not overlap with any other image or video. The method further includes transmitting the one or more occlude-free regions to a receiver; and rendering an output video that includes the first video input with the one or more second video inputs overlaid in a region not including the one or more occlude-free regions.

Additional embodiments will be set forth in the description that follows and, in part, will be apparent from the description, and/or may be learned by practice of the presented embodiments of the disclosure.

### BRIEF DESCRIPTION OF THE DRAWINGS

The above and other features and aspects of embodiments of the disclosure will be apparent from the following description taken in conjunction with the accompanying drawings, in which:

FIG. 1 is a diagram of an example network device, in accordance with various embodiments of the present disclosure.

FIG. 2 is a flow chart of an example process for defining an occlude-free region, in accordance with various embodiments of the present disclosure.

FIG. 3 is a diagram of the occlude-free and occluded regions in accordance with various embodiments of the present disclosure.

FIG. 4 is a diagram of the 360 video system in accordance with various embodiments of the present disclosure.

FIG. 5 is a diagram of the 360 video system in accordance with various embodiments of the present disclosure.

### DETAILED DESCRIPTION OF THE INVENTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

When using conventional methods for video conferencing with a 360 video, the current systems rely on transcribing a 360 video to 2-dimensional space and overlaying the 2-d drawing with other pertinent information. For example, when a user is in a 360 conference with some sort of presentation, the current systems need to choose to either display the conference (360 video), the presentation (2D video) or some sort of overlapped rendering of the conference video with the presentation drawn over part of the conference. Due to the increased occurrence of remote work, the need for collaboration between peers requires a better way to see both the participants and the subject matter of the virtual meetings.

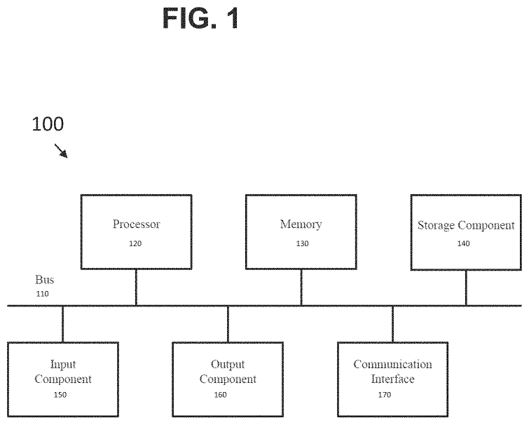

FIG. 1 illustrates an exemplary system 100 of an embodiment for using the 360 video conferencing method. The exemplary system 100, may be one of a variety of systems such as a personal computer, a mobile device, a cluster of computers, a server, embedded device, ASIC, microcontroller, or any other device capable of running code. Bus 110 connects the exemplary system 100 together such that all the components may communication with one another. The bus 110 connects the processor 120, the memory 130, the storage component 140, the input component 150, the output component 160 and the interface component.

The processor 120 may be a single processor, a processor with multiple processors inside, a cluster (more than one) of processors, and/or a distributed processing. The processor carries out the instructions stored in both the memory 130 and the storage component 140. The processor 120 operates as the computational device, carrying out operations for the text normalization apparatus. Memory 130 is fast storage and retrieval to any of the memory devices may be enabled through the use of cache memory, which may be closely associated with one or more CPU. Storage component 140 may be one of any longer term storage such as a HDD, SSD, magnetic tape or any other long term storage format.

Input component 150 may be any file type or signal from a user interface component such as a camera or text capturing equipment. Output component 160 outputs the processed information to the communication interface 170. The communication interface may be a speaker or other communication device, which may display information to a user or a another observer such as another computing system.

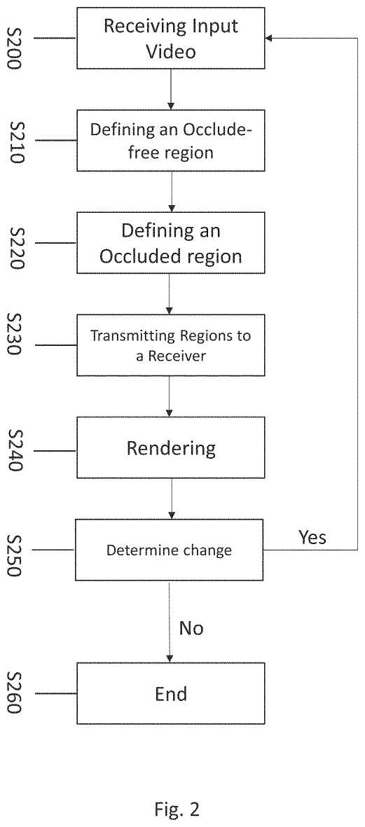

FIG. 2 illustrates a flowchart of an example embodiment of the process of performing a video conferencing. The operations detailed in the process comprise receiving an input video 200, defining an occlude-free region 210, and defining an occluded region 220. The defined regions of 210 and 220 are transmitted to a receiver 230. Next, rendering 240 occurs, which draws an output video with some combination of the occlude-free and the occluded video. Then the process determines whether there is a change 250 which restarts the process at receiving an input video 200. If no change is determined, the process ends 260.

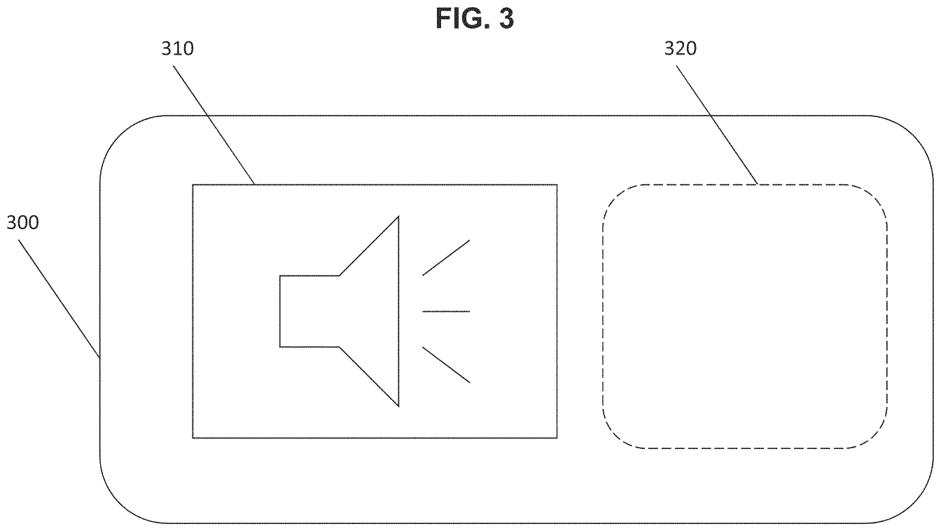

FIG. 3 illustrates an embodiment of an occluded region 320 and occlude-free region 310. On a screen 300, the space may be allocated for either an occlude-free region 310 or an occluded region 320. An occluded region 310 is a region of the screen 300 where content or other information is being drawn/rendered or otherwise outputted to. This occluded region 310 may not have other content rendered on top of or otherwise overlapped. Meanwhile, occluded region 320, is free of content, has low priority content, or has been marked as an region that may have other content placed over it. An occlude-free region is defined by its location in that coordinate system and its region in that coordinate system. For instance, a spherical rectangular region is defined by its center, and its yaw and pitch range around the center. Similarly, in various coordinate systems, a region may be defined using the parameters of that coordinate system. In some embodiments, regions of a screen 300, whole screens or plurality of screens may be marked as either occluded or occluded free regions.

Various mechanisms may be used for signaling an occlude-free region. For example, in some embodiments the signaling an occlude-free region may be sending the coordinate of such region as an item in the list of occlude-free regions as part of the session description. In other embodiments, signaling an occlude-free region may be done by defining a node in scene description that defines the occlude-free region and its property (e.g., being transparent and does not contain any media objects). In other embodiments, signaling an occlude-free region may be performed by defining a separate scene description that only defines the collude-free regions. An occlude-free region of a 360 video may be signaled in the SDP a=3gpp_occludefree attribute. The video component may have the location and size (range) of the region. Since the component is defined by 3gpp_occludefree, the ITT4RT knows that this signaling doesn't contain any actual media, but is used for signaling the region that should not be covered.

In some embodiments, the scene description may include a node for each occlude-free region. The node texture properties may be set to an alpha channel with an opacity of 0 (complete transparency). Alternatively, a new MIME type may be defined for occlude-free nodes. For example, in the glTF scene description, if for a texture the alphaMode=MASK, and alphaCutOff=1.1, then the object is transparent (not rendered). A new attribute may be added to the glTF specification to explicitly signal these regions as occlude free region.

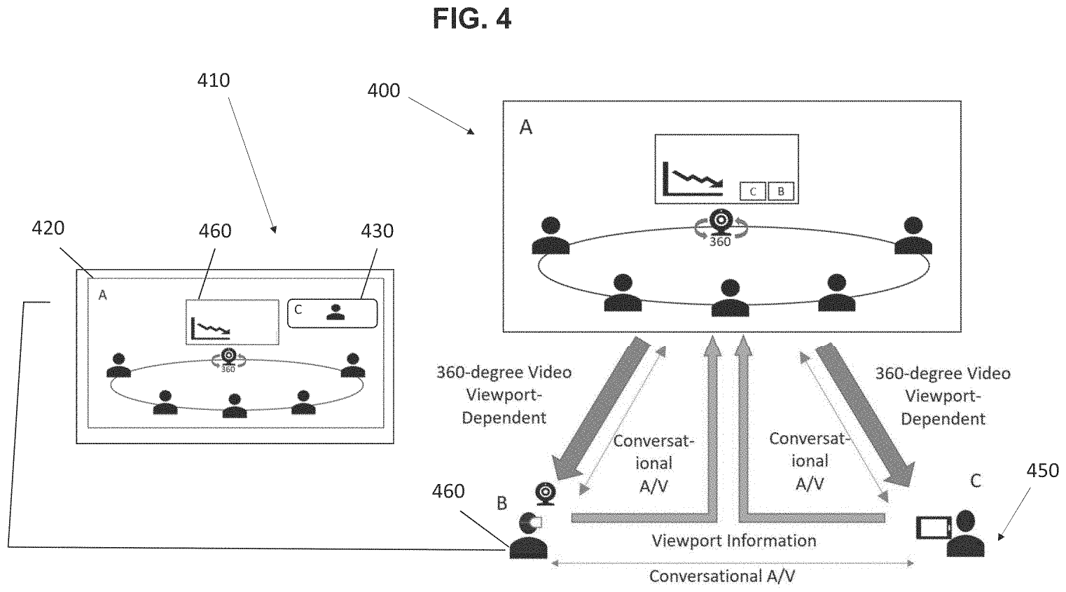

FIG. 4 details an embodiment of the 360 video system in use. In the exemplary embodiment, a 360 video presentation is being conducted. The video presentation, for example, may be a video conference, a video chat, a video or other information exchange where visual and audio information is present. In this embodiment, user B 460, receives a 360 video from user A 400 and a 2-d video from user C 450. The user may want to see both videos on his/her terminal. However, if the user wants to take the most advantage of the device display, room A's 360-video may need to take the entire screen of user B's device, and then, the 2-d video from user C must be overlaid on top of room A 400's 360-video. In this embodiment, User B's 460 video feed 420 is a combination of user's A video 400 as the background, which then has occlude-free and occluded regions defined. These regions of user's A video 400 are transmitted from a sender to a receiver or shared through other software solutions or devices. Here, user B 460 sends their video information to user C 450 and user A 400. Additionally, User A 400 and User C 450 send each of their individual video information between themselves and to User B 460. The occlude-free regions may be described with a separate scene description object than a regular scene description. This additional scene description only contains information about occlude-free regions and therefore is not used for rendering, but provides a map for occlude-free regions.

After receiving information about the other user's video display, the regions are defined as occluded or occlude-free, and then a combination of two is rendered on user B's screen 410. User B's screen 410, shown in FIG. 4, uses users A's screen 400 as a background with at least one region marked as occluded free 460 and another region marked as occluded 430. In FIG. 4, the occluded region 430 has user C's video 440 drawn on the region. In some cases, the arrangement of one or more of the screens may need to change because of new information, such as additional users, more presentation information being drawn or for example, a user becoming the focal point or otherwise requiring more screen real estate. With the additional information, each user's screen will require that the occluded or occlude-free regions be redefined to change and account for the changing circumstances. For example, referring to FIG. 4, if an additional user were to join in the presentation, all the user's present screens would have to redefine the occluded or occlude-free regions and re-render each of the user's screen to ensure that key information is not occluded.

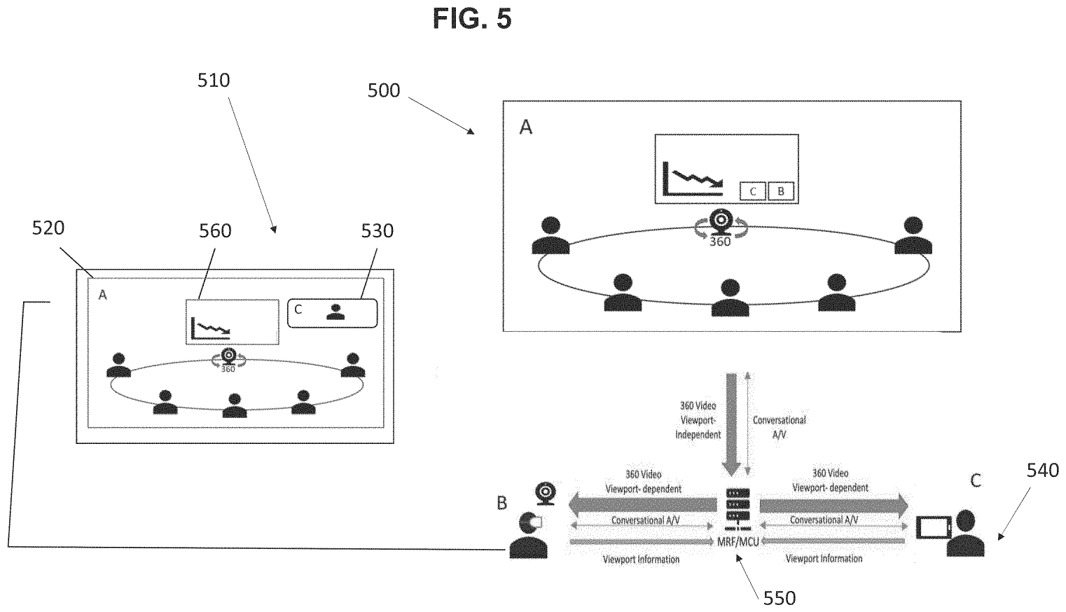

FIG. 5 details an embodiment of the 360 video system in use. In the exemplary embodiment, a 360 video presentation is being conducted. The video presentation, for example, may be a video conference, a video chat, a video or other information exchange where visual and audio information is present. In this embodiment, user B 460, receives a 360 video from user A 500 and a 2-d video from user C 540. The user may want to see both videos on his/her terminal. However, if the user wants to take the most advantage of the device display, room A's 360-video may need to take the entire screen of user B's device, and then, the 2-d video from user C must be overlaid on top of room A's 360-video. In this embodiment, User B's video feed 520 is a combination of user's A video 500 as the background, which then has occlude-free and occluded regions defined. These regions of user's A video 500 are transmitted from a sender to a receiver through an MRF 550, or shared through other software solutions or devices. The MRF 550 may be used to create a single scene description for a conversational session. This scene description describes the overall scene to each remote client. The same scene description optionally may include additional nodes to signal the occlude-free regions, or it may include a separate root node that only contains the nodes for occlude-free regions.

Here, user B sends their video information to user C and user A. Additionally, User A and User C send each of their individual video information between themselves and to User B. The occlude-free regions may be described with a separate scene description object than a regular scene description. This additional scene description only contains information about occlude-free regions and therefore, is not used for rendering, but provides a map for occlude-free regions.

After receiving information about the other user's video display, the regions are defined as occluded or occlude-free then a combination of two is rendered on user B's screen 510. User B's screen 510, shown in FIG. 5, uses users A's screen 500 as a background with at least one region marked as occluded free 560 and anther marked as occluded 530. In FIG. 5, the occluded region 530 has user C's video 440 drawn on the region. In some cases, the arrangement of one or more of the screens may need to change because of new information, such as additional users, more presentation information being drawn or for example, a user becoming the focal point or otherwise requiring more screen real estate. With the additional information, each user's screen will require that the occluded or occlude-free regions be redefined to change and account for the changing circumstances. For example, using FIG. 5, if an additional user were to join in the presentation, the screens of all user's present would have to redefine the occluded or occlude-free regions and re-render each of the user's screen to ensure that key information is not occluded.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium may be a tangible device that may retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local region network, a wide region network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or obj ect code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local region network (LAN) or a wide region network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, implement the operations specified in the flowchart and/or block diagram block or blocks. These computer readable program instructions may also be stored in a computer readable storage medium that may direct a computer, a programmable data processing apparatus, and/or other devices to operate in a particular manner, such that the computer readable storage medium having instructions stored therein comprises an article of manufacture including instructions which implement aspects of the operations specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the operations specified in the flowchart and/or block diagram block or blocks.

The flowchart and block diagrams in the figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical operation(s). The method, computer system, and computer readable medium may include additional blocks, fewer blocks, different blocks, or differently arranged blocks than those depicted in the Figures. In some alternative implementations, the operations noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified operations or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

The above disclosure also encompasses the embodiments listed below:

(1) A method of defining occlude free regions in 360 video conferencing, the method performed by at least one processor including: receiving a first video input that corresponding to a 360-degree video conference; receiving one or more second video inputs; defining one or more regions in the first video input as occlude-free regions that do not overlap with any other image or video; transmitting the one or more occlude-free regions to a receiver; and rendering an output video that includes the first video input with the one or more second video inputs overlaid in a region not including the one or more occlude-free regions.

(2) The method of feature (1), in which the occlude-free region is defined by a location of the occlude-free region in a coordinate system.

(3) The method according to feature (1) or (2), in which the one or more second video inputs is a 360-degree video or a 2-D video.

(4) The method according to any one of features (1)-(3), in which the occlude-free regions are dynamic and change during a video conferencing session.

(5) The method according to any one of features (1)-(4), further including: responding to a change in the at least one information in the input video by changing the rendering in the output video.

(6) The method according to any one of features (1)-(5), in which signaling of the occlude-free region includes one or more of the following operations: sending the coordinates of the one or more occlude-free regions as an item in a list of occlude-free regions as part of a session description; defining a node in a scene description that defines the one or more occlude-free regions and properties of the one or more occlude-free regions; defining a separate scene description that only defines the occlude-free regions.

(7) The method according to any one of features (1)-(6), in which the information of each occlude-free region is updated during the session, and a new occlude-free region is added or an existing occlude-free region is removed.

(8) An apparatus for defining occlude free regions in 360 video conferencing, the apparatus including: at least one memory configured to store computer program code; at least one processor configured to access the computer program code and operate as instructed by the computer program code, the computer program code including: first receiving code configured to cause the at least one processor to receive a first video input that corresponding to a 360-degree video conference; second receiving code configured to cause the at least one processor to receive one or more second video inputs; defining code configured to cause the at least one processor to define one or more regions in the first video input as occlude-free regions that do not overlap with any other image or video; transmitting code configured to cause the at least one processor to transmit the one or more occlude-free regions to a receiver; and rendering code configured to cause the at least one processor to render an output video that includes the first video input with the one or more second video inputs overlaid in a region not including the one or more occlude-free regions.

(9) The apparatus of feature (8), in which the occlude-free region is defined by a location of the occlude-free region in a coordinate system.

(10) The apparatus according to feature (8) or (9), in which the one or more second video inputs is a 360-degree video or a 2-D video.

(11) The apparatus according to any one of features (8)-(10), in which the occlude-free regions are dynamic and change during a video conferencing session.

(12) The apparatus according to any one of features (8)-(11), further including: responding code configured to cause the at least one processor to respond to a change in the at least one information in the input video by changing the rendering in the output video.

(13) The apparatus according to any one of features (8)-(12), in which the signaling code configured to cause the at least on processor to signal the occlude-free region further causes the at least one processor to perform one or more of the following operations: send the coordinates of the one or more occlude-free regions as an item in a list of occlude-free regions as part of a session description; define a node in a scene description that defines the one or more occlude-free regions and properties of the one or more occlude-free regions; define a separate scene description that only defines the occlude-free regions.

(14) The apparatus according to any one of features (8)-(13), in which the information of each occlude-free region is updated during the session, and a new occlude-free region is added or an existing occlude-free region is removed.

(15) A non-transitory computer readable medium having stored thereon computer instructions that when executed by at least one processor cause the at least one processor to: receive a first video input that corresponding to a 360-degree video conference; receive one or more second video inputs; define one or more regions in the first video input as occlude-free regions that do not overlap with any other image or video; transmit the one or more occlude-free regions to a receiver; and rendering an output video that includes the first video input with the one or more second video inputs overlaid in a region not including the one or more occlude-free regions.

(16) The non-transitory computer readable medium according to feature (15), in which the occlude-free region is defined by a location of the occlude-free region in a coordinate system.

(17) The non-transitory computer readable medium according to feature (15) or (16), in which the one or more second video inputs is a 360-degree video or a 2-D video.

(18) The non-transitory computer readable medium according to any one of features (15)-(17), wherein the occlude-free regions are dynamic and change during a video conferencing session.

(19) The non-transitory computer readable medium according to any one of features (15)-(18), further causing the at least one processor to: respond to a change in the at least one information in the input video by changing the rendering in the output video.

(20) The non-transitory computer readable medium according any one of features (15)-(19), in which signaling of the occlude-free region includes one or more of the following operations: sending the coordinates of the one or more occlude-free regions as an item in a list of occlude-free regions as part of a session description; defining a node in a scene description that defines the one or more occlude-free regions and properties of the one or more occlude-free regions; defining a separate scene description that only defines the occlude-free regions.

What is claimed is:

1. A method of defining occlude free regions in 360 video conferencing, the method performed by at least one processor comprising:
receiving a first video input that corresponding to a 360-degree video conference;
receiving one or more second video inputs;
defining one or more regions in the first video input as occlude-free regions that do not overlap with any other image or video;
transmitting the one or more occlude-free regions to a receiver; and
rendering an output video that includes the first video input with the one or more second video inputs overlaid in a region not including the one or more occlude-free regions.

2. The method of claim 1, wherein the occlude-free region is defined by a location of the occlude-free region in a coordinate system.

3. The method of claim 1, wherein the one or more second video inputs is a 360-degree video or a 2-D video.

4. The method of claim 1, wherein the occlude-free regions are dynamic and change during a video conferencing session.

5. The method of claim 1, further comprising:
responding to a change in the at least one information in the input video by changing the rendering in the output video.

6. The method of claim 1, wherein signaling of the occlude-free region includes one or more of the following operations:
i) sending the coordinates of the one or more occlude-free regions as an item in a list of occlude-free regions as part of a session description;
ii) defining a node in a scene description that defines the one or more occlude-free regions and properties of the one or more occlude-free regions;
iii) defining a separate scene description that only defines the occlude-free regions.

7. The method of claim 1, wherein the information of each occlude-free region is updated during the session, and a new occlude-free region is added or an existing occlude-free region is removed.

8. An apparatus for defining occlude free regions in 360 video conferencing, the apparatus comprising:
at least one memory configured to store computer program code;
at least one processor configured to access the computer program code and operate as instructed by the computer program code, the computer program code including:
first receiving code configured to cause the at least one processor to receive a first video input that corresponding to a 360-degree video conference;
second receiving code configured to cause the at least one processor to receive one or more second video inputs;
defining code configured to cause the at least one processor to define one or more regions in the first video input as occlude-free regions that do not overlap with any other image or video;
transmitting code configured to cause the at least one processor to transmit the one or more occlude-free regions to a receiver; and
rendering code configured to cause the at least one processor to render an output video that includes the first video input with the one or more second video inputs overlaid in a region not including the one or more occlude-free regions.

9. The apparatus according to claim 8, wherein the occlude-free region is defined by a location of the occlude-free region in a coordinate system.

10. The apparatus according to claim 8, wherein the one or more second video inputs is a 360-degree video or a 2-D video.

11. The apparatus according to claim 8, wherein the occlude-free regions are dynamic and change during a video conferencing session.

12. The apparatus according to claim 8, further comprising:
responding code configured to cause the at least one processor to respond to a change in the at least one information in the input video by changing the rendering in the output video.

13. The apparatus according to claim 8, wherein the signaling code configured to cause the at least on processor to signal the occlude-free region further causes the at least one processor to perform one or more of the following operations:
i) send the coordinates of the one or more occlude-free regions as an item in a list of occlude-free regions as part of a session description;
ii) define a node in a scene description that defines the one or more occlude-free regions and properties of the one or more occlude-free regions;
iii) define a separate scene description that only defines the occlude-free regions.

14. The apparatus according to claim 8, wherein the information of each occlude-free region is updated during the session, and a new occlude-free region is added or an existing occlude-free region is removed.

15. A non-transitory computer readable medium having stored thereon computer instructions that when executed by at least one processor cause the at least one processor to:
receive a first video input that corresponding to a 360-degree video conference;
receive one or more second video inputs;
define one or more regions in the first video input as occlude-free regions that do not overlap with any other image or video;
transmit the one or more occlude-free regions to a receiver; and rendering an output video that includes the first video input with the one or more second video inputs overlaid in a region not including the one or more occlude-free regions.

16. The non-transitory computer readable medium according to claim 15, wherein the occlude-free region is defined by a location of the occlude-free region in a coordinate system.

17. The non-transitory computer readable medium according to claim 15, wherein the one or more second video inputs is a 360-degree video or a 2-D video.

18. The non-transitory computer readable medium according to claim 15, wherein the occlude-free regions are dynamic and change during a video conferencing session.

19. The non-transitory computer readable medium according to claim 15, further causing the at least one processor to:
respond to a change in the at least one information in the input video by changing the rendering in the output video.

20. The non-transitory computer readable medium according to claim 15, wherein signaling of the occlude-free region includes one or more of the following operations:
i) sending the coordinates of the one or more occlude-free regions as an item in a list of occlude-free regions as part of a session description;
ii) defining a node in a scene description that defines the one or more occlude-free regions and properties of the one or more occlude-free regions;
iii) defining a separate scene description that only defines the occlude-free regions.
